(19) United States
(12) Patent Application Publication
(10) Pub. No.: US 2026/0370502 A1
(43) Pub. Date: Nov. 19, 2026

(54) SYSTEMS AND METHODS FOR STREAMLINED POLICY CONTROL MESSAGING IN A WIRELESS NETWORK

(71) Applicant: Verizon Patent and Licensing Inc., Basking Ridge, NJ (US)

(72) Inventors: Violeta Cakulev, Milburn, NJ (US); Lixia Yan, Basking Ridge, NJ (US); Ali Imdad Malik, East Brunswick, NJ (US); Hossein M. Ahmadi, Parsippany, NJ (US)

(73) Assignee: Verizon Patent and Licensing Inc., Basking Ridge, NJ (US)

(21) Appl. No.: 19/209,289

(22) Filed: May 15, 2025

(51) Int. Cl. H04L 12/14; H04W 8/20; H04W 60/04

(52) U.S. Cl. CPC H04L 12/1407; H04W 8/20; H04W 60/04

(57) ABSTRACT

A system described herein may receive communication information associated with a policy element of a wireless network that maintains User Equipment ("UE") policies and Access and Mobility ("AM") policies. The policy element may include a Policy Control Function ("PCF"), such as a UE-AM PCF that implements a UE PCF and an AM PCF. The system may output, using the communication information, a message to the policy element, where the message includes a UE policy control request associated with a particular UE, and an AM policy control request associated with the particular UE. The system may receive, from the policy element and in response to the message UE policy information, and AM policy information. The system may enforce the AM policies, and may provide the UE policies to the particular UE such that the UE is able to enforce or implement the UE policies.

### BACKGROUND

Wireless networks provide wireless connectivity to User Equipment ("UEs"), such as mobile telephones, tablets, Internet of Things ("IoT") devices, Machine-to-Machine ("M2M") devices, or the like. Wireless networks may include Network Functions ("NFs") that perform various operations relating to providing network services such as routing, authentication, Quality of Service ("QoS") management, or the like. Some wireless networks include an NF, such as a Policy Control Function ("PCF"), that maintains or propagates policy information related to the operation of the network.

For example, such policies may include UE policies, such as network discovery and/or selection policies (e.g., Wireless Local Area Network ("WLAN") selection policies, N3 Interworking Function ("N3IWF") selection policies, Evolved Packet Data Gateway ("ePDG") selection policies, or the like), UE Route Selection Policy ("URSP") rules, Vehicle to Everything ("V2X") policies, or other types of policies that may be implemented by a UE. The policies maintained or propagated by a PCF may include access and mobility ("AM") policies, such as service area restrictions for a given UE (e.g., allowed or non-allowed Tracking Area Identifiers ("TAIs")), spectrum or band permission information for a given UE, or other policies that may be enforced by an access and/or mobility management entity of the wireless network, such as an Access and Mobility Management Function ("AMF"). The policies maintained or propagated by a PCF may include session management ("SM") policies, which may include QoS policies, charging policies, or other session-based policies that may be enforced by a session management element of the wireless network, such as a Session Management Function ("SMF").

Some wireless networks may implement NFs in a containerized or virtualized environment. In this manner, the same type of NF may be deployed as multiple instances, such as geographically distributed instances. Further, the implementation of some NFs may be logically split. For example, a PCF may be implemented in a wireless network as one or more UE PCFs (e.g., PCFs that maintain or propagate UE policies), one or more AM PCFs (e.g., PCFs that maintain or propagate AM policies), and/or one or more SM PCFs (e.g., PCFs that maintain or propagate SM policies). In some deployments, multiple NFs (or multiple logical splits of the same NF) may be implemented by the same container, device, machine, etc. For example, a particular container, device, machine, etc. may implement both a UE PCF instance and an AM PCF instance.

### BRIEF DESCRIPTION OF THE DRAWINGS

FIG. 1 illustrates an example arrangement of a UE-AM PCF, in accordance with some embodiments;

FIG. 2 illustrates example routing information associated with NFs of a wireless network, in accordance with some embodiments;

FIG. 3 illustrates an example signal flow for streamlined policy control messaging in a wireless network, in accordance with some embodiments;

FIG. 4 illustrates examples of policy control messaging sent to a UE-AM PCF, in accordance with some embodiments;

FIG. 5 illustrates an example of streamlined policy updates in a wireless network, in accordance with some embodiments;

FIG. 6 illustrates an example process for streamlined policy control messaging, in accordance with some embodiments;

FIGS. 7 and 8 illustrate example environments in which one or more embodiments, described herein, may be implemented;

FIG. 9 illustrates an example arrangement of a radio access network ("RAN"), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein may streamline policy control messaging in a wireless network, such as by reducing the quantity of policy control messages sent in a wireless network without reducing or diminishing network functionality. For example, as noted above, some wireless networks may implement a split functionality of a policy element (e.g., a PCF), such as by implementing a UE PCF that is associated with (e.g., maintains, provides, etc.) UE policies, an AM PCF that is associated with AM policies, and an SM PCF that is associated with SM policies. In some deployments, multiple different PCF splits may be implemented at the same container, device, pod, machine (e.g., virtual machine or "bare metal" machine), virtualized instance, etc. Routing mechanisms within the network may be used to direct messages to a given container, device, pod, machine, virtualized instance, or the like, such as Internet Protocol ("IP") addresses, hostnames, instance identifiers, or the like. In some implementations, UE PCFs and AM PCFs may be implemented by the same container, device, pod, machine, virtualized instance, or the like (referred to herein as a "UE-AM PCF instance" or simply as a "UE-AM PCF").

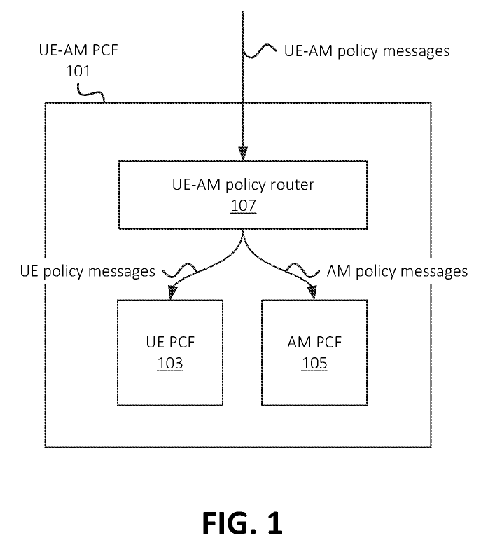

For example, as shown in FIG. 1, UE-AM PCF 101 may implement (e.g., may implement the functionality of, may include, etc.) UE PCF 103, AM PCF 105, and UE-AM policy router 107. In accordance with some embodiments, UE-AM PCF 101 may receive UE-AM policy messages, which may include policy control messages for UE policies and/or AM policies. Policy control messages, as referred to herein, may include instructions, requests, commands, or the like, related to the creation, modification, and/or termination of policy control associations. A UE policy control association, for a given UE, may be used by UE PCF 103 to maintain, provide, receive updates to, etc. UE policies for the given UE. Similarly, an AM policy control association, for a given UE, may be used by AM PCF 105 to maintain, provide, receive updates to, etc. AM policies for the given UE.

UE-AM PCF 101 may be associated with a particular IP address, a particular instance identifier, a particular container identifier, a particular hostname, or other suitable identifier used by other NFs to route traffic (e.g., UE and/or AM policies) to UE-AM PCF 101. In some embodiments, UE PCF 103 and/or AM PCF 105 may also be associated with a respective IP address, instance identifier, container identifier, hostname, or the like. For example, in some embodiments, NFs of the wireless network may be able to separately send traffic (e.g., policy control messages or other suitable messages) to UE PCF 103 and/or to AM PCF 105 directly (e.g., by using the IP address, instance identifier, etc. of UE PCF 103 and/or AM PCF 105 in lieu of using the IP address, instance identifier, etc. of UE-AM PCF 101). In other embodiments, UE PCF 103 and/or AM PCF 105 may not be associated with their own distinct IP addresses, instance identifiers, etc., and may be communicated with via UE-AM PCF 101.

In accordance with some embodiments described herein, UE-AM policy router 107 may serve as an entry point or interface, via which other NFs of the network may communicate with UE PCF 103 and/or AM PCF 105. For example, traffic sent by another NF to UE-AM PCF 101 may be received by UE-AM policy router 107. UE-AM policy router 107 may, for example, receive a single message that includes policy control messages related to both UE PCF 103 and AM PCF 105. For example, UE-AM policy router 107 may identify header information and/or may identify protocol-level messages in a message body to identify whether traffic, received by UE-AM PCF 101, includes a UE policy control message, an AM policy control message, or both. As shown, UE-AM policy router 107 may accordingly route, forward, etc. UE policy control messages to UE PCF 103, and may further route, forward, etc. AM policy control messages to AM PCF 103. In some embodiments, UE-AM PCF 101, and/or one or more other elements of a wireless network, may perform some or all of the functionality described herein with respect to UE-AM policy router 107.

As discussed below, since other NFs of the network are able to send both UE and AM policy control messages to the same particular container, instance, etc. (e.g., UE-AM PCF 101), such NFs may send UE and AM policy control messages in the same message to UE-AM PCF 101, and may thus avoid sending multiple discrete messages such as a first message to UE PCF 103 with a UE policy control message, in addition to a second message to AM PCF 105 with an AM policy control message. In situations where UE and AM policy control messages are typically sent at the same time or within relatively short timeframes, combining UE and AM policy control messages in the manner described herein may be in line with the operation of the network, while reducing the quantity of messages sent or received via the network. As such, the overall efficiency of the network may be increased, inasmuch as the burden on routing elements or other elements of the network may be reduced by way of the reduced policy control messaging described herein.

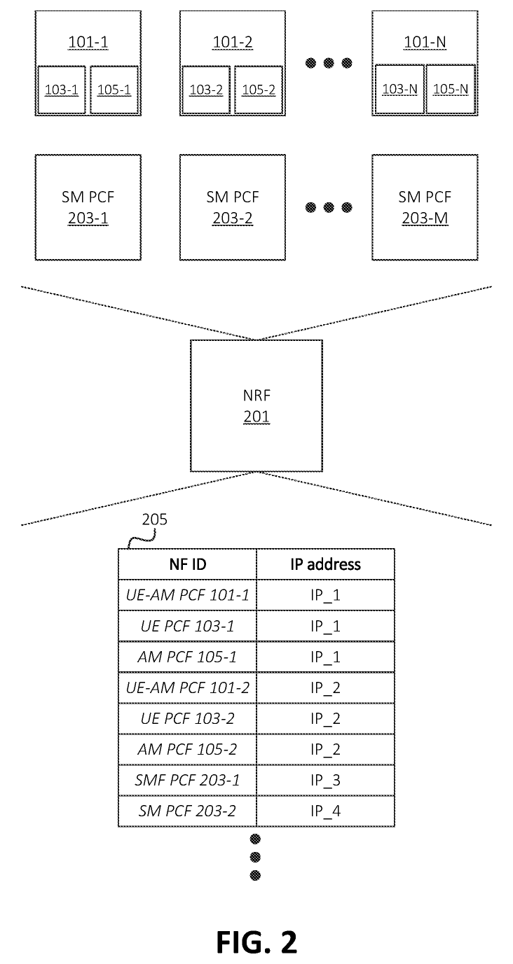

As shown in FIG. 2, a network repository element of the wireless network, such as Network Repository Function ("NRF") 201, may maintain routing information associated with some or all of the NFs of a wireless network, including routing information for different instances of the same NF or NF type. As shown in this figure, NRF 201 may maintain routing information for multiple UE-AM PCFs or UE-AM PCF instances (e.g., UE-AM PCFs-1 through 101-N) and for multiple SM PCFs or SM PCF instances (e.g., SM PCFs 203-1 through 203-M). As noted above, UE-AM PCFs-1 may be associated with the same container, the same set of hardware resources, the same IP address, the same hostname, the same instance identifier, etc. For example, given UE-AM PCF 101 may include or implement a given UE PCF 103 and/or AM PCF 105, as discussed above. For example, UE-AM PCF 101-1 may include or implement UE PCF 103-1 and AM PCF 105-1 (e.g., in addition to a respective UE-AM policy router 107, as discussed above), UE-AM PCF 101-2 may include or implement UE PCF 103-2 and AM PCF 105-2, and UE-AM PCF 101-N may include or implement UE PCF 103-N and AM PCF 105-N.

Routing information (e.g., represented in data structure 205) for different UE-AM PCFs may include different IP addresses. In some embodiments, the routing information may include device identifiers, instance identifiers, hostnames, and/or other suitable identifiers in addition to or in lieu of IP addresses. As shown, for example, UE-AM PCF 101-1 may be associated with a first IP address ("IP_1"), UE-AM PCF 101-2 may be associated with a second IP address ("IP_2"), and so on. In some embodiments, the corresponding UE PCFs 103 and/or AM PCFs 105 for a given UE-AM PCF 101 may be associated with the same IP address as such UE-AM PCF 101. For example, UE PCF 103-1 and AM PCF 105-1 may be associated with the same IP address as UE-AM PCF 101-1, UE PCF 103-2 and AM PCF 105-2 may be associated with the same IP address as UE-AM PCF 101-2, and so on. As discussed above, in this manner, other NFs of the wireless network may be able to send traffic such as policy control messages to UE PCF 103-1 and AM PCF 105-1 in a single message, and may also be able to separately send traffic to UE PCF 103-1 and AM PCF 105-1 separately. For example, such traffic may include header information or other information that indicates that the traffic includes UE policy information and/or is otherwise addressed to UE PCF 103-1. That is, in some situations, a message with a single header (or a single set of header information) may be used for traffic that includes both UE policy control information and AM policy control information, which may consume fewer network resources than two messages with two headers (or two sets of header information), where one message (along with its corresponding header information) includes UE policy control information and where another message (along with its corresponding header information) includes AM policy control information. Routing elements of the network may utilize routing information (e.g., data structure 205 maintained or provided by NRF 201) to route such traffic using the IP address "IP_1." As discussed above, 101-1 may further process the traffic (e.g., as discussed above with respect to UE-AM policy router 107) and provide the traffic to UE PCF 103-1.

As additionally shown in FIG. 2, data structure 205 may include the same IP address for UE-AM PCF 101-2, UE PCF 103-2, and AM PCF 105-2. Data structure 205 may also include respective IP addresses for other NFs of the network, including a third IP address for SM PCF 203-1 and a third IP address for SM PCF 203-2.

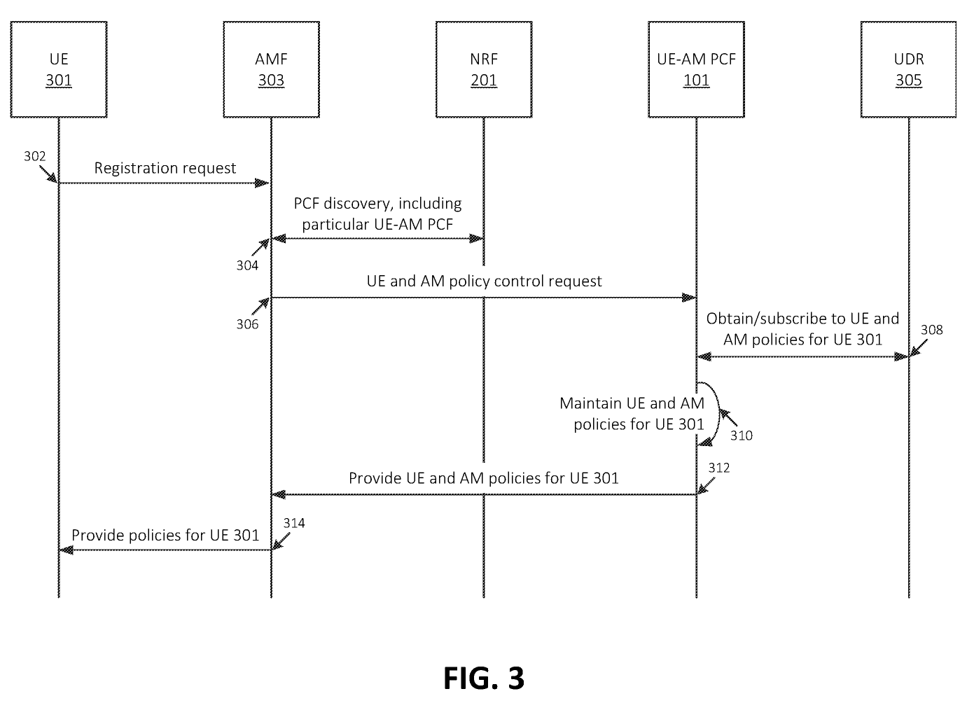

FIG. 3 illustrates an example signal flow for streamlined policy control messaging in a wireless network. As shown, a particular UE 301 may output (at 302) a registration request to a particular AMF 303 of a wireless network. For example, UE 301 may connect to a RAN that is communicatively coupled to or otherwise associated with AMF 303, and may output the registration request via Non-Access Stratum ("NAS") signaling in order to register with the wireless network. In some embodiments, the registration request may be part of a handover procedure and/or may be some other type of request. In some embodiments, the registration request or a handover request may be received from some other device or system (e.g., other than UE 301). AMF 303 may, based on receiving (at 302) the registration request and/or based on some other suitable triggering event, may perform (at 304) a PCF discovery procedure, in which AMF 303 identifies one or more policy elements with which to establish a policy control context for UE 301. The discovery procedure may include, for example, outputting a request to NRF 201. For example, AMF 303 may request an IP address or other routing information for a respective UE PCF 103, AM PCF 105, and/or SM PCF 203 that should be communicated with in order to establish or maintain policy information for UE 301 and/or for communication sessions between the network and UE 301. NRF 201 may identify a particular UE PCF 103, AM PCF 105, and/or SM PCF 203 based on the request. In some embodiments, the discovery procedure may include NRF 201 identifying a particular UE-AM PCF 101 (e.g., that implements UE PCF 103 and AM PCF 105). The discovery procedure (at 304) may further include NRF 201 providing routing information for the identified UE-AM PCF 101, PCF 103, AM PCF 105, and/or SM PCF 203 to AMF 303.

Further based on the registration request (e.g., as part of a registration procedure for UE 301), AMF 303 may output (at 306) a UE and AM policy control request to UE-AM PCF 101. In accordance with some embodiments, the policy control request may be a single request (e.g., a single message, such as a single message sent to an IP address or other suitable identifier of UE-AM PCF 101), as opposed to a series of messages. For example, the UE and AM policy control request may be associated with UE policies as well as AM policies associated with UE 301. In some embodiments, the UE and AM policy control request may include an Npcf_AMUEPolicyControl_Create request, an Npcf_UEAMPolicyControl_Create request, and/or some other protocol-level request that requests the creation of a policy control context for UE policies as well as AM policies associated with UE 301. In some embodiments, the UE and AM policy control request may include a UE policy control creation request (e.g., an Npcf_UEPolicyControl_Create request) as well as an AM policy control creation request (e.g., an Npcf_AMPolicyControl_Create request) that are included in, encapsulated in, etc. a single message that is sent to UE-AM PCF 101 (e.g., to an IP address or other suitable identifier of UE-AM PCF 101).

Based on the request, UE-AM PCF 101 may accordingly obtain and/or subscribe to (at 308) UE policies and AM policies associated with UE 301. For example, UE-AM PCF 101 may request UE policies and AM policies, associated with UE 301, from an information repository of the wireless network such as Unified Data Repository ("UDR") 305. Subscribing to UE policies and/or AM policies may include indicating, to UDR 305, that UE-AM PCF 101 should be notified when UE policies and/or AM policies associated with UE 301 are updated (e.g., that such updates should be "pushed" to UE-AM PCF 101). In some embodiments, when obtaining or subscribing to UE policies and AM policies associated with UDR 305, UE-AM PCF 101 may output a single request to UDR 305, that specifies both AM policies and UE policies associated with UE 301. In other implementations, UE-AM PCF 101 may output, to UDR 305, a first request for AM policies associated with UE 301 and a second request for UE policies associated with UE 301.

UE-AM PCF 101 may accordingly receive and maintain (at 310) the UE policies and AM policies associated with UE 301. In some embodiments, UE-AM PCF 101 may aid in the enforcement of the UE policies and AM policies associated with UE 301, such as by providing the policies to other NFs of the network and/or to UE 301. For example, as shown, UE-AM PCF 101 may provide (at 312) the UE policies and AM policies, associated with UE 301, to AMF 303. In some embodiments, the UE policies and AM policies may be sent in a single message to AMF 303. In some embodiments, the UE policies and AM policies may be sent in separate messages (e.g., as a first message or set of messages that include the UE policies for UE 301 and a second message or set of messages that include the AM policies for UE 301).

AMF 303 may accordingly enforce or otherwise implement the AM policies for UE 301. As one example, AMF 303 may determine whether to accept the registration request based on the AM policies for UE 301. AMF 303 may further provide (at 314) the UE policies to UE 301 (e.g., via NAS signaling). UE 301 may accordingly enforce or otherwise implement the UE policies. For example, UE 301 may utilize URSP rules included in the UE policies when requesting the establishment of communication sessions (e.g., protocol data unit ("PDU") sessions) with the network, selecting a RAN or access point via which to connect to the network, etc.

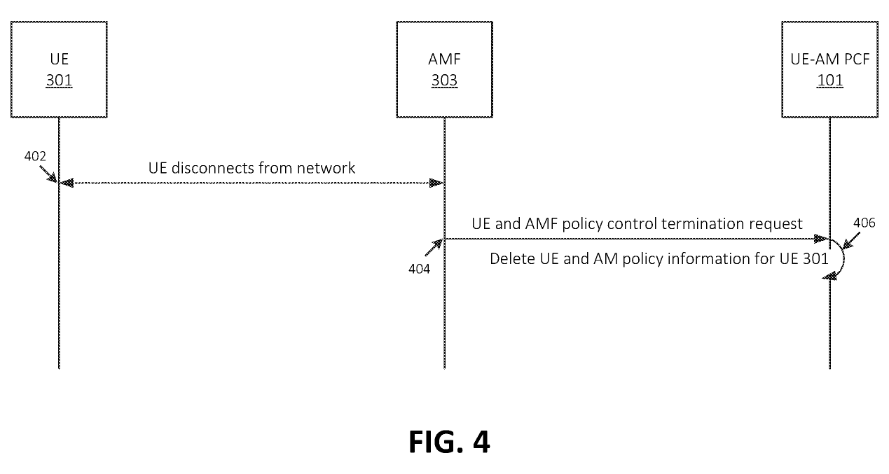

In some embodiments, a single policy control message may be used to terminate UE and AM policy contexts at UE-AM PCF 101. For example, as shown in FIG. 4, UE 301 may disconnect (at 402) from the network. For example, UE 301 may move out of range of a RAN of the network, may power down, and/or may otherwise no longer be connected to the network. AMF 303 may identify (at 402) that UE 301 has disconnected from the network. As another example, AMF 303 may initiate a disconnection of UE 301 from the network, such as based on one or more AM policies maintained or enforced by AMF 303. Based on the disconnection of UE 301 from the network, AMF 303 may output (at 404) a UE and AM policy control termination request to UE-AM PCF 101. As similarly discussed above, the UE and AM policy control termination request may include a single request or message sent to an IP address or other suitable identifier of UE-AM PCF 101 (e.g., an Npcf_AMUEPolicyControl_Delete request, an Npcf_UEAMPolicyControl_Delete request, and/or some other protocol-level request that requests the deletion of a policy control context for UE policies as well as AM policies associated with UE 301). In some embodiments, the UE and AM policy control deletion request may include a UE policy control deletion request (e.g., an Npcf_UEPolicyControl_Delete request) as well as an AM policy control deletion request (e.g., an Npcf_AMPolicyControl_Delete request) that are included in, encapsulated in, etc. a single message that is sent to UE-AM PCF 101 (e.g., to an IP address or other suitable identifier of UE-AM PCF 101).

Accordingly, UE-AM PCF 101 may delete (at 406) UE policy control information and AM policy control information associated with UE 301. For example, UE-AM PCF 101 may delete policy information, context information, etc. that includes UE policies and AM policies associated with UE 301, thus freeing up resources of UE-AM PCF 101. For example, UE-AM policy router 107 may identify a UE policy termination request (e.g., which may be included in a UE policy and AM policy termination request) and forward such request to UE PCF 103 of UE-AM PCF 101, and may identify an AM policy control termination request (e.g., which may be included in a UE policy and AM policy termination request) and forward such request to AM PCF 105 of UE-AM PCF 101.

FIG. 4 illustrates an example embodiment in which AMF 303 outputs a single request, a single message, etc. that indicates a UE policy control deletion request as well as an AM policy control deletion request. In some embodiments, similar concepts may apply for other types of UE and AM policy control messages, requests, etc. from AMF 303. For example, in some embodiments, AMF 303 may identify or determine that UE policies and AM policies for a particular UE 301 should be modified. In some such embodiments, AMF 303 may output (e.g., to UE-AM PCF 101) a single UE and AM policy modification request, message, etc. that indicates an updated set of UE policies and an updated set of AM policies. For example, the UE and AM policy modification request may include a UE policy control modification request (e.g., an Npcf_UEPolicyControl_Modify request) as well as an AM policy control modification request (e.g., an Npcf_AMPolicyControl_Modify request). Based on the UE and AM policy modification request, UE-AM PCF 101 may update or modify one or more UE policies and/or AM policies associated with a given UE.

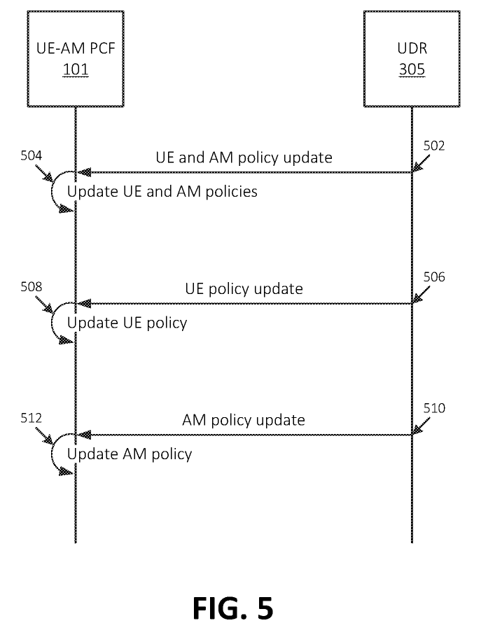

As discussed above, UE-AM PCF 101 may subscribe to UE policy updates and/or AM policy updates associated with a particular UE 301. Based on such subscriptions, UDR 305 may automatically notify UE-AM PCF 101 when any such policies are updated at UDR 305 (e.g., when UDR 305 receives modified UE and/or AM policy information for a given UE 301). As shown in FIG. 5, for example, when a UE policy and an AM policy, applicable to a particular UE 301, are updated at UDR 305, UDR 305 may output (at 502) the updated UE and AM policies to UE-AM PCF 101. For example, UDR 305 may output (at 502) updated UE information that includes the UE and AM policies to UE-AM PCF 101.

UE-AM PCF 101 may accordingly update (at 504) the UE and/or AM policies for UE 301, which may include modifying locally maintained UE policies and/or AM policies for UE 301. Additionally, in some embodiments, UE-AM PCF 101 may provide (e.g., push) the updated AM policies and/or UE policies to AMF 303. AMF 303 may update its maintained AM policies for UE 301, and/or may provide the updated UE policies to UE 301.

As another example, when only a UE policy for UE 301 is updated at UDR 305, UDR 305 may provide (at 506) the updated UE policy to UE-AM PCF 101. In one example, the update to the UE policy may be received by UDR 305 from AMF 303 or from some other suitable source. UE-AM PCF 101 may accordingly update (at 508) the UE policies for UE 301, which may include modifying locally maintained UE policies for UE 301. Additionally, in some embodiments, UE-AM PCF 101 may provide (e.g., push) the updated UE policies to AMF 303, which may provide the updated UE policies to UE 301.

As another example, when only an AM policy for UE 301 is updated at UDR 305, UDR 305 may provide (at 510) the updated AM policy to UE-AM PCF 101. UE-AM PCF 101 may accordingly update (at 512) the AM policies for UE 301, which may include modifying locally maintained AM policies for UE 301. Additionally, in some embodiments, UE-AM PCF 101 may provide (e.g., push) the updated AM policies to AMF 303, which may update its maintained AM policies for UE 301.

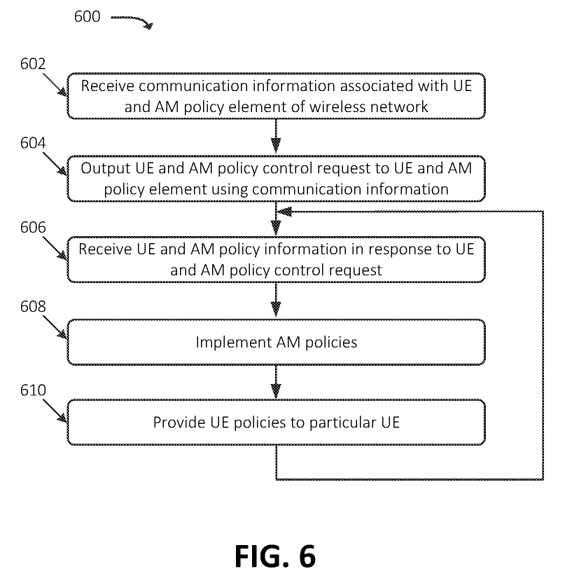

FIG. 6 illustrates an example process 600 for streamlined policy control messaging in a wireless network. In some embodiments, some or all of process 600 may be performed by AMF 303. In some embodiments, one or more other devices may perform some or all of process 600 in concert with, and/or in lieu of, AMF 303.

As shown, process 600 may include receiving (at 602) communication information associated with a UE and AM policy element of a wireless network, such as UE-AM PCF 101. As discussed above, UE-AM PCF 101 may include, may implement, etc. a particular UE PCF 103 and a particular AM PCF 105. For example, UE-AM PCF 101 may maintain UE policies as well as AM policies (e.g., different sets of policies that are associated with or are applicable to a particular UE 301). The communication information may include an IP address, a hostname, routing information, or other suitable information based on which AMF 303 may be able to communicate with (e.g., send and/or receive traffic to and/or from) UE-AM PCF 101.

Process 600 may further include outputting (at 604) a UE and AM policy control request to UE-AM PCF 101 using the communication information. For example, AMF 303 may output a single message (e.g., a single message directed to the IP address or other communication information of UE-AM PCF 101) that includes a policy control request for UE policies as well as AM policies associated with a particular UE 301. For example, as discussed above, the policy control request may include a Npcf_AMUEPolicyControl_Create request, an Npcf_UEAMPolicyControl_Create request, an Npcf_UEPolicyControl_Create request, an Npcf_AMPolicyControl_Create request, or the like. In some situations, as discussed above, AMF 303 may also output other types of policy control requests using the communication information, such as an Npcf_AMUEPolicyControl_Delete request, an Npcf_UEAMPolicyControl_Delete request, an Npcf_UEPolicyControl_Delete request, an Npcf_AMPolicyControl_Delete request, or the like.

Process 600 may additionally include receiving (at 606) UE and AM policy information in response to the UE and AM policy control request. For example, as discussed above, AMF 303 may receive a message that includes UE policies associated with UE 301, AM policies associated with UE 301, or both UE and AM policies associated with UE 301. In some embodiments, as discussed above, AMF 303 may receive (at 606) UE and/or AM policy information automatically from UE-AM PCF 101, such as in situations where such policy information is changed (e.g., at UDR 305).

Process 600 may also include implementing (at 608) the AM policies. For example, as discussed above, AMF 303 may implement AM policies such as by using such policies when making determinations such as whether to allow UE 301 to access the network, whether to allow UE 301 to access certain network slices or QoS parameters of the network, etc.

Process 600 may further include providing (at 610) the UE policies to UE 301. UE 301 may implement the UE policies, such as when implementing URSP rules indicated in the UE policies, requesting connections to particular gateways or access points based on the UE policies, etc.

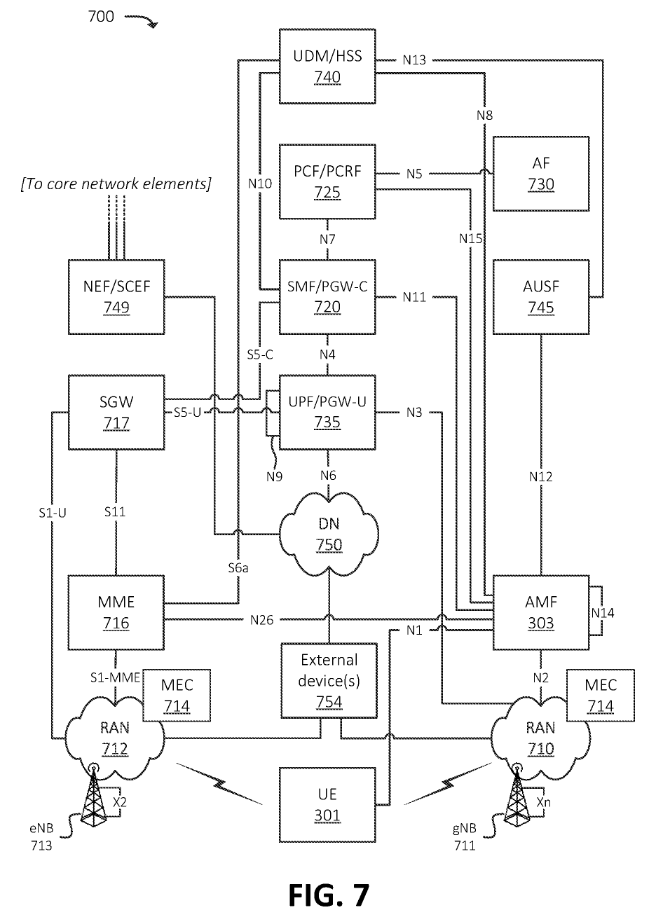

FIG. 7 illustrates an example environment 700, in which one or more embodiments may be implemented. In some embodiments, environment 700 may correspond to a Fifth Generation ("5G") network, and/or may include elements of a 5G network. In some embodiments, environment 700 may correspond to a 5G Non-Standalone ("NSA") architecture, in which a 5G radio access technology ("RAT") may be used in conjunction with one or more other RATs (e.g., a Long-Term Evolution ("LTE") RAT), and/or in which elements of a 5G core network may be implemented by, may be communicatively coupled with, and/or may include elements of another type of core network (e.g., an evolved packet core ("EPC")). In some embodiments, portions of environment 700 may represent or may include a 5G core ("5GC"). As shown, environment 700 may include UE 301, RAN 710 (which may include one or more Next Generation Node Bs ("gNBs") 711), RAN 712 (which may include one or more evolved Node Bs ("eNBs") 713), and various network functions such as AMF 303, Mobility Management Entity ("MME") 716, Serving Gateway ("SGW") 717, SMF/Packet Data Network ("PDN") Gateway ("PGW")-Control plane function ("PGW-C") 720, Policy Control Function ("PCF")/Policy Charging and Rules Function ("PCRF") 725, Application Function ("AF") 730, User Plane Function ("UPF")/PGW-User plane function ("PGW-U") 735, Unified Data Management ("UDM")/Home Subscriber Server ("HSS") 740, Authentication Server Function ("AUSF") 745, and Network Exposure Function ("NEF")/Service Capability Exposure Function ("SCEF") 749. Environment 700 may also include one or more networks, such as Data Network ("DN") 750. Environment 700 may include one or more additional devices or systems communicatively coupled to one or more networks (e.g., DN 750), such as one or more external devices 754.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple "slices" of a core network, where each slice includes a discrete and/or logical set of network functions (e.g., one slice may include a first instance of AMF 303, SMF/PGW-C 720, PCF/PCRF 725, and/or UPF/PGW-U 735, while another slice may include a second instance of AMF 303, SMF/PGW-C 720, PCF/PCRF 725, and/or UPF/PGW-U 735). The different slices may provide differentiated levels of service, such as service in accordance with different QoS parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Additionally, one or more elements of environment 700 may be implemented in a virtualized and/or containerized manner. For example, one or more of the elements of environment 700 may be implemented by one or more Virtualized Network Functions ("VNFs"), Cloud-Native Network Functions ("CNFs"), etc. In such embodiments, environment 700 may include, may implement, and/or may be communicatively coupled to an orchestration platform that provisions hardware resources, installs containers or applications, performs load balancing, and/or otherwise manages the deployment of such elements of environment 700. In some embodiments, such orchestration and/or management of such elements of environment 700 may be performed by, or in conjunction with, the open-source Kubernetes^{®} application programming interface ("API") or some other suitable virtualization, containerization, and/or orchestration system.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces ("SBIs"), including an Namf interface, an Nudm interface, an Npcf interface, an Nupf interface, an Nnef interface, an Nsmf interface, and/or one or more other SBIs.

UE 301 may include a computation and communication device, such as a wireless mobile communication device that is capable of communicating with RAN 710, RAN 712, and/or DN 750. UE 301 may be, or may include, a radiotelephone, a personal communications system ("PCS") terminal (e.g., a device that combines a cellular radiotelephone with data processing and data communications capabilities), a personal digital assistant ("PDA") (e.g., a device that may include a radiotelephone, a pager, Internet/intranet access, etc.), a smart phone, a laptop computer, a tablet computer, a camera, a personal gaming system, an Internet of Things ("IoT") device (e.g., a sensor, a smart home appliance, a wearable device, a programmable logic controller or other industrial controller, a Machine-to-Machine ("M2M") device, or the like), a Fixed Wireless Access ("FWA") device, or another type of mobile computation and communication device. UE 301 may send traffic to and/or receive traffic (e.g., user plane traffic) from DN 750 via RAN 710, RAN 712, and/or UPF/PGW-U 735.

RAN 710 may be, or may include, a 5G RAN that implements a 5G RAT and that includes one or more base stations (e.g., one or more gNBs 711), via which UE 301 may communicate with one or more other elements of environment 700. UE 301 may communicate with RAN 710 via an air interface (e.g., as provided by gNB 711). For instance, RAN 710 may receive traffic (e.g., user plane traffic such as voice call traffic, data traffic, messaging traffic, etc.) from UE 301 via the air interface, and may communicate the traffic to UPF/PGW-U 735 and/or one or more other devices or networks. Further, RAN 710 may receive signaling traffic, control plane traffic, etc. from UE 301 via the air interface, and may communicate such signaling traffic, control plane traffic, etc. to AMF 303 and/or one or more other devices or networks. Additionally, RAN 710 may receive traffic intended for UE 301 (e.g., from UPF/PGW-U 735, AMF 303, and/or one or more other devices or networks) and may communicate the traffic to UE 301 via the air interface.

RAN 712 may be, or may include, an LTE RAN that implements an LTE RAT and that includes one or more base stations (e.g., one or more eNBs 713), via which UE 301 may communicate with one or more other elements of environment 700. UE 301 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 301 via the air interface, and may communicate the traffic to UPF/PGW-U 735 (e.g., via SGW 717) and/or one or more other devices or networks. Further, RAN 712 may receive signaling traffic, control plane traffic, etc. from UE 301 via the air interface, and may communicate such signaling traffic, control plane traffic, etc. to MME 716 and/or one or more other devices or networks. Additionally, RAN 712 may receive traffic intended for UE 301 (e.g., from UPF/PGW-U 735, MME 716, SGW 717, and/or one or more other devices or networks) and may communicate the traffic to UE 301 via the air interface.

One or more RANs of environment 700 (e.g., RAN 710 and/or RAN 712) may include, may implement, and/or may otherwise be communicatively coupled to one or more edge computing devices, such as one or more Multi-Access/Mobile Edge Computing ("MEC") devices (referred to sometimes herein simply as a "MECs") 714. MECs 714 may be co-located with wireless network infrastructure equipment of RANs 710 and/or 712 (e.g., one or more gNBs 711 and/or one or more eNBs 713, respectively). Additionally, or alternatively, MECs 714 may otherwise be associated with geographical regions (e.g., coverage areas) of wireless network infrastructure equipment of RANs 710 and/or 712. In some embodiments, one or more MECs 714 may be implemented by the same set of hardware resources, the same set of devices, etc. that implement wireless network infrastructure equipment of RANs 710 and/or 712. In some embodiments, one or more MECs 714 may be implemented by different hardware resources, a different set of devices, etc. from hardware resources or devices that implement wireless network infrastructure equipment of RANs 710 and/or 712. In some embodiments, MECs 714 may be communicatively coupled to wireless network infrastructure equipment of RANs 710 and/or 712 (e.g., via a high-speed and/or low-latency link such as a physical wired interface, a high-speed and/or low-latency wireless interface, or some other suitable communication pathway).

MECs 714 may include hardware resources (e.g., configurable or provisionable hardware resources) that may be configured to provide services and/or otherwise process traffic to and/or from UE 301, via RAN 710 and/or 712. For example, RAN 710 and/or 712 may route some traffic from UE 301 (e.g., traffic associated with one or more particular services, applications, application types, etc.) to a respective MEC 714 instead of to core network elements of 700 (e.g., UPF/PGW-U 735). MEC 714 may accordingly provide services to UE 301 by processing such traffic, performing one or more computations based on the received traffic, and providing traffic to UE 301 via RAN 710 and/or 712. MEC 714 may include, and/or may implement, some or all of the functionality described above with respect to UPF/PGW-U 735, AF 730, one or more application servers, and/or one or more other devices, systems, VNFs, CNFs, etc. In this manner, ultra-low latency services may be provided to UE 301, as traffic does not need to traverse links (e.g., backhaul links) between RAN 710 and/or 712 and the core network.

AMF 303 may include one or more devices, systems, VNFs, CNFs, etc., that perform operations to register UE 301 with the 5G network, to establish bearer channels associated with a session with UE 301, to hand off UE 301 from the 5G network to another network, to hand off UE 301 from the other network to the 5G network, manage mobility of UE 301 between RANs 710 and/or gNBs 711, and/or to perform other operations. In some embodiments, the 5G network may include multiple AMFs 303, which communicate with each other via the N14 interface (denoted in FIG. 7 by the line marked "N14" originating and terminating at AMF 303).

MME 716 may include one or more devices, systems, VNFs, CNFs, etc., that perform operations to register UE 301 with the EPC, to establish bearer channels associated with a session with UE 301, to hand off UE 301 from the EPC to another network, to hand off UE 301 from another network to the EPC, manage mobility of UE 301 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 301. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 301, from DN 750, and may forward the user plane data toward UE 301 (e.g., via RAN 710, SMF/PGW-C 720, and/or one or more other devices). In some embodiments, multiple instances of UPF/PGW-U 735 may be deployed (e.g., in different geographical locations), and the delivery of content to UE 301 may be coordinated via the N9 interface (e.g., as denoted in FIG. 7 by the line marked "N9" originating and terminating at UPF/PGW-U 735). Similarly, UPF/PGW-U 735 may receive traffic from UE 301 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. In some embodiments, UDM/HSS 740 may include, may implement, may be communicatively coupled to, and/or may otherwise be associated with some other type of repository or database, such as UDR 305. AUSF 745 and/or UDM/HSS 740 may perform authentication, authorization, and/or accounting operations associated with one or more UEs 301 and/or one or more communication sessions associated with one or more UEs 301.

DN 750 may include one or more wired and/or wireless networks. For example, DN 750 may include an Internet Protocol ("IP")-based PDN, a wide area network ("WAN") such as the Internet, a private enterprise network, and/or one or more other networks. UE 301 may communicate, through DN 750, with data servers, other UEs 301, and/or to other servers or applications that are coupled to DN 750. DN 750 may be connected to one or more other networks, such as a public switched telephone network ("PSTN"), a public land mobile network ("PLMN"), and/or another network. DN 750 may be connected to one or more devices, such as content providers, applications, web servers, and/or other devices, with which UE 301 may communicate.

External devices 754 may include one or more devices or systems that communicate with UE 301 via DN 750 and one or more elements of 700 (e.g., via UPF/PGW-U 735). External devices 754 may include, for example, one or more application servers, content provider systems, web servers, or the like. External devices 754 may, for example, implement "server-side" applications that communicate with "client-side" applications executed by UE 301. External devices 754 may provide services to UE 301 such as gaming services, videoconferencing services, messaging services, email services, web services, and/or other types of services. Operations described above with respect to a given external device 754 (e.g., in accordance with some embodiments) may be performed by a single device, by a cloud computing system, by one or more devices that implement a virtualized or containerized environment, a collection of devices, etc.

In some embodiments, external devices 754 may communicate with one or more elements of environment 700 (e.g., core network elements) via NEF/SCEF 749. NEF/SCEF 749 include one or more devices, systems, VNFs, CNFs, etc. that provide access to information, APIs, and/or other operations or mechanisms of one or more core network elements to devices or systems that are external to the core network (e.g., to external device 754 via DN 750). NEF/SCEF 749 may maintain authorization and/or authentication information associated with such external devices or systems, such that NEF/SCEF 749 is able to provide information, that is authorized to be provided, to the external devices or systems. For example, a given external device 754 may request particular information associated with one or more core network elements. NEF/SCEF 749 may authenticate the request and/or otherwise verify that external device 754 is authorized to receive the information, and may request, obtain, or otherwise receive the information from the one or more core network elements. In some embodiments, NEF/SCEF 749 may include, may implement, may be implemented by, may be communicatively coupled to, and/or may otherwise be associated with a Security Edge Protection Proxy ("SEPP"), which may perform some or all of the functions discussed above. External device 754 may, in some situations, subscribe to particular types of requested information provided by the one or more core network elements, and the one or more core network elements may provide (e.g., "push") the requested information to NEF/SCEF 749 (e.g., in a periodic or otherwise ongoing basis).

In some embodiments, external devices 754 may communicate with one or more elements of RAN 710 and/or 712 via an API or other suitable interface. For example, a given external device 754 may provide instructions, requests, etc. to RAN 710 and/or 712 to provide one or more services via one or more respective MECs 714. In some embodiments, such instructions, requests, etc. may include QoS parameters, Service Level Agreements ("SLAs"), etc. (e.g., maximum latency thresholds, minimum throughput thresholds, etc.) associated with the services.

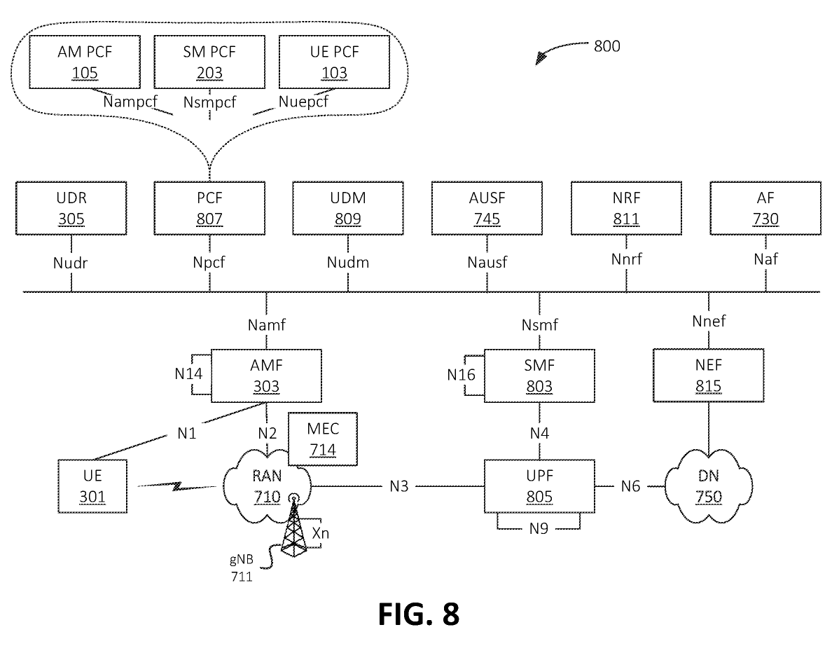

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 301, RAN 710 (which may include one or more gNBs 711 or other types of wireless network infrastructure) and various network functions, which may be implemented as VNFs, CNFs, etc. Such network functions may include AMF 303, SMF 803, UPF 805, PCF 807, UDM 809, AUSF 745, Network Repository Function ("NRF") 811, AF 730, UDR 305, and NEF 815. Environment 800 may also include or may be communicatively coupled to one or more networks, such as DN 750.

The example shown in FIG. 8 illustrates one instance of each network component or function (e.g., one instance of SMF 803, UPF 805, PCF 807, UDM 809, AUSF 745, etc.). In practice, environment 800 may include multiple instances of such components or functions. For example, in some embodiments, environment 800 may include multiple "slices" of a core network, where each slice includes a discrete and/or logical set of network functions (e.g., one slice may include a first instance of SMF 803, PCF 807, UPF 805, etc., while another slice may include a second instance of SMF 803, PCF 807, UPF 805, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture ("SBA"), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 303), an Nudm interface (e.g., indicating communications to be routed to UDM 809), an Npcf interface, an Nupf interface, an Nnef interface, an Nsmf interface, an Nnrf interface, an Nudr interface, an Naf interface, and/or one or more other SBIs.

UPF 805 may include one or more devices, systems, VNFs, CNFs, etc., that receive, route, process, and/or forward traffic (e.g., user plane traffic). As discussed above, UPF 805 may communicate with UE 301 via one or more communication sessions, such as PDU sessions. Such PDU sessions may be associated with a particular network slice or other suitable QoS parameters, as noted above. UPF 805 may receive downlink user plane traffic (e.g., voice call traffic, data traffic, etc. destined for UE 301) from DN 750, and may forward the downlink user plane traffic toward UE 301 (e.g., via RAN 710). In some embodiments, multiple UPFs 805 may be deployed (e.g., in different geographical locations), and the delivery of content to UE 301 may be coordinated via the N9 interface. Similarly, UPF 805 may receive uplink traffic from UE 301 (e.g., via RAN 710), and may forward the traffic toward DN 750. In some embodiments, UPF 805 may implement, may be implemented by, may be communicatively coupled to, and/or may otherwise be associated with UPF/PGW-U 735. In some embodiments, UPF 805 may communicate (e.g., via the N4 interface) with SMF 803, regarding user plane data processed by UPF 805 (e.g., to provide analytics or reporting information, to receive policy and/or authorization information, etc.).

PCF 807 may include one or more devices, systems, VNFs, CNFs, etc., that aggregate, derive, generate, etc. policy information associated with the 5GC and/or UEs 301 that communicate via the 5GC and/or RAN 710. PCF 807 may receive information regarding policies and/or subscriptions from one or more sources, such as subscriber databases (e.g., UDM 809, UDR 305, etc.), and/or from one or more users such as, for example, an administrator associated with PCF 807. In some embodiments, the functionality of PCF 807 may be split into multiple network functions or subsystems, such as AM PCF 105, SM PCF 203, UE PCF 103, and so on. Such different "split" PCFs may be associated with respective SBIs (e.g., AM PCF 105 may be associated with an Nampcf SBI, SM PCF 203 may be associated with an Nsmpcf SBI, UE PCF 103 may be associated with an Nuepcf SBI, and so on) via which other network functions may communicate with the split PCFs. As discussed above, in some implementations, a split functionality of PCF 807 may include implementing a particular UE PCF 103 and a particular AM PCF 105 by a particular UE-AM PCF 101. In such implementations, UE-AM PCF 101 may be associated with the Nuepcf SBI, the Nampcf SBI, and/or an SBI that is associated with both UE PCF 103 and a particular AM PCF 105 (e.g., an Nueampcf SBI, an Namuepcf SBI, or some other suitable SBI).

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 305 may include one or more devices, systems, VNFs, CNFs, etc. that provide user and/or subscriber information, based on which PCF 807 and/or other elements of environment 800 may determine access policies, QoS policies, charging policies, or the like. In some embodiments, UDR 305 may receive such information from UDM 809 and/or one or more other sources.

NEF 815 include one or more devices, systems, VNFs, CNFs, etc. that provide access to information, APIs, and/or other operations or mechanisms of the 5GC to devices or systems that are external to the 5GC. NEF 815 may maintain authorization and/or authentication information associated with such external devices or systems, such that NEF 815 is able to provide information, that is authorized to be provided, to the external devices or systems. Such information may be received from other network functions of the 5GC (e.g., as authorized by an administrator or other suitable entity associated with the 5GC), such as SMF 803, UPF 805, a charging function ("CHF") of the 5GC, and/or other suitable network function. NEF 815 may communicate with external devices or systems (e.g., external devices 754) via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 303 may include, may implement, may be implemented by, and/or may otherwise be associated with MME 716; SMF 803 may include, may implement, may be implemented by, and/or may otherwise be associated with SGW 717; PCF 807 may include, may implement, may be implemented by, and/or may otherwise be associated with a PCRF (e.g., PCF/PCRF 725); NEF 815 may include, may implement, may be implemented by, and/or may otherwise be associated with a SCEF (e.g., NEF/SCEF 749); and so on.

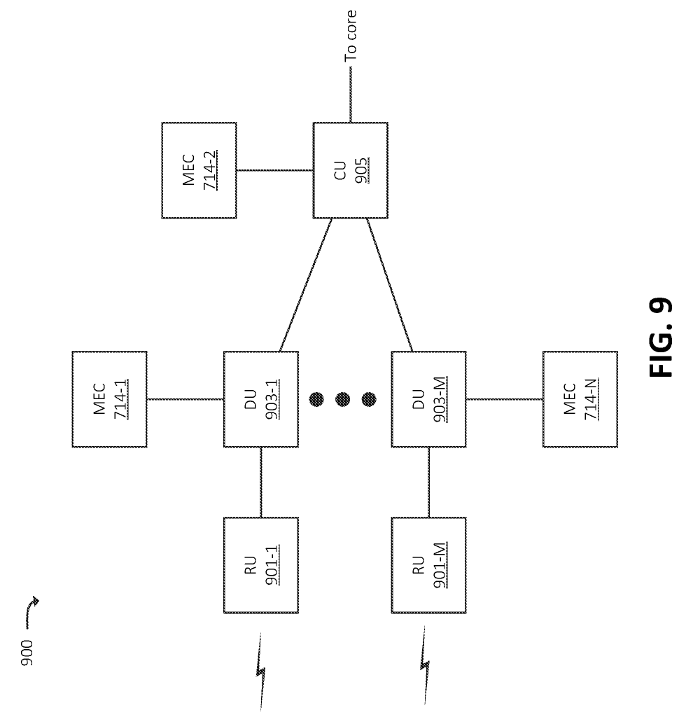

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit ("CU") 905, one or more Distributed Units ("DUs") 903-1 through 903-M (referred to individually as "DU 903," or collectively as "DUs 903"), and one or more Radio Units ("RUs") 901-1 through 901-M (referred to individually as "RU 901," or collectively as "RUs 901").

CU 905 may communicate with a core of a wireless network (e.g., may communicate with one or more of the devices or systems described above with respect to FIG. 8, such as AMF 303 and/or UPF 805) and/or some other device or system such as MEC 714. In the uplink direction (e.g., for traffic from UEs 301 to a core network), CU 905 may aggregate traffic from DUs 903, and forward the aggregated traffic to the core network. In some embodiments, CU 905 may receive traffic according to a given protocol (e.g., Radio Link Control ("RLC") traffic) from DUs 903, and may perform higher-layer processing (e.g., may aggregate/process RLC packets and generate Packet Data Convergence Protocol ("PDCP") packets based on the RLC packets) on the traffic received from DUs 903.

CU 905 may receive downlink traffic (e.g., traffic from the core network, traffic from a given MEC 714, etc.) for a particular UE 301, and may determine which DU(s) 903 should receive the downlink traffic. DU 903 may include one or more devices that transmit traffic between a core network (e.g., via CU 905) and UE 301 (e.g., via a respective RU 901). DU 903 may, for example, receive traffic from RU 901 at a first layer (e.g., physical ("PHY") layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 301.

RU 901 may include hardware circuitry (e.g., one or more RF transceivers, antennas, radios, and/or other suitable hardware) to communicate wirelessly (e.g., via an RF interface) with one or more UEs 301, one or more other DUs 903 (e.g., via RUs 901 associated with DUs 903), and/or any other suitable type of device. In the uplink direction, RU 901 may receive traffic from UE 301 and/or another DU 903 via the RF interface and may provide the traffic to DU 903. In the downlink direction, RU 901 may receive traffic from DU 903, and may provide the traffic to UE 301 and/or another DU 903.

One or more elements of RAN environment 900 may, in some embodiments, be communicatively coupled to one or more MECs 714. For example, DU 903-1 may be communicatively coupled to MEC 714-1, DU 903-M may be communicatively coupled to MEC 714-N, CU 905 may be communicatively coupled to MEC 714-2, and so on. MECs 714 may include hardware resources (e.g., configurable or provisionable hardware resources) that may be configured to provide services and/or otherwise process traffic to and/or from UE 301, via a respective RU 901.

For example, DU 903-1 may route some traffic, from UE 301, to MEC 714-1 instead of to a core network via CU 905. MEC 714-1 may process the traffic, perform one or more computations based on the received traffic, and may provide traffic to UE 301 via RU 901-1. As discussed above, MEC 714 may include, and/or may implement, some or all of the functionality described above with respect to UPF 805, AF 730, and/or one or more other devices, systems, VNFs, CNFs, etc. In this manner, ultra-low latency services may be provided to UE 301, as traffic does not need to traverse DU 903, CU 905, links between DU 903 and CU 905, and an intervening backhaul network between RAN environment 900 and the core network.

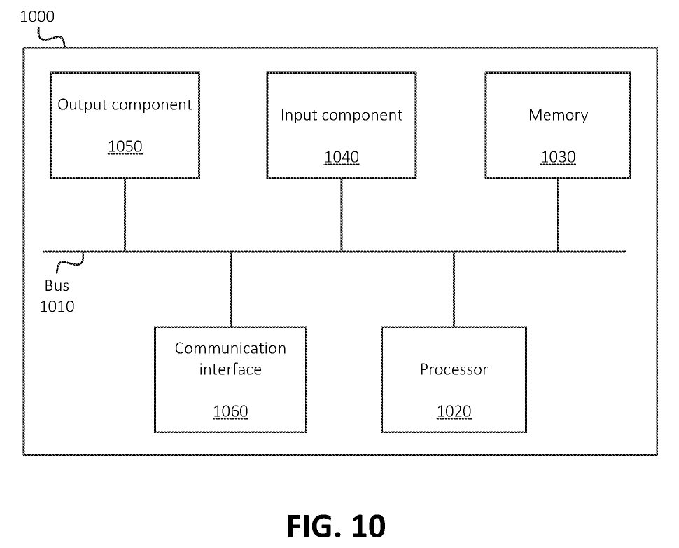

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, a graphics processing unit ("GPU"), a GPU-based processing unit, a neural processing unit ("NPU"), or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System ("GPS")-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes ("LEDs"), etc.

Communication interface 1060 may include any transceiver-like mechanism that enables device 1000 to communicate with other devices and/or systems (e.g., via RAN 710, RAN 712, DN 750, etc.). For example, communication interface 1060 may include an Ethernet interface, an optical interface, a coaxial interface, or the like. Communication interface 1060 may include a wireless communication device, such as an infrared ("IR") receiver, a Bluetooth^{®} radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

In a first example embodiment, a device comprises one or more processors configured to: receive communication information associated with a policy element of a wireless network that maintains UE policies and AM policies; and output, using the communication information, a message to the policy element, wherein the message includes a UE policy control request associated with a particular UE and an AM policy control request associated with the particular UE. The one or more processors are further configured to receive, from the policy element and in response to the message, UE policy information and AM policy information.

A second example embodiment includes the device of the first example embodiment, wherein the policy element includes a PCF.

A third example embodiment includes the device of the second example embodiment, wherein the PCF implements an AM PCF and a UE PCF.

A fourth example embodiment includes the device of the first example embodiment, wherein the communication information includes an IP address associated with the policy element.

A fifth example embodiment includes the device of the fourth example embodiment, wherein the message includes a single message that is directed to the IP address associated with the policy element.

A sixth example embodiment includes the device of the first example embodiment, wherein the message includes an Npcf_UEPolicyControl_Create request and an Npcf_AMPolicyControl_Create request.

A seventh example embodiment may include the device of the first example embodiment, wherein the one or more processors are further configured to: enforce the AM policy information with respect to the particular UE; and provide the UE policy information to the particular UE.

Some example embodiments include a non-transitory computer-readable medium, storing plurality of processor-executable instructions to perform one or more operations described above with respect to the first through the seventh embodiments, and/or other embodiments described above. Some example embodiments include a method that includes performing one or more of the operations described above with respect to the first through the seventh embodiments, and/or other embodiments described above.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks, operations, and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set. Concepts described above may be embodied by, for example, a device, devices, a system, systems, a method, methods, a non-transitory computer-readable medium, and/or non-transitory computer-readable media, as provided for in the claims.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known "opt-in" or "opt-out" processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term "and," as used herein, does not necessarily preclude the interpretation that the phrase "and/or" was intended in that instance. Similarly, an instance of the use of the term "or," as used herein, does not necessarily preclude the interpretation that the phrase "and/or" was intended in that instance. Also, as used herein, the article "a" is intended to include one or more items, and may be used interchangeably with the phrase "one or more." Where only one item is intended, the terms "one," "single," "only," or similar language is used. Further, the phrase "based on" is intended to mean "based, at least in part, on" unless explicitly stated otherwise.

What is claimed is:

1. A device, comprising:
one or more processors configured to:
receive communication information associated with a policy element of a wireless network that maintains User Equipment ("UE") policies and Access and Mobility ("AM") policies;
output, using the communication information, a message to the policy element, wherein the message includes:
a UE policy control request associated with a particular UE, and
an AM policy control request associated with the particular UE; and
receive, from the policy element and in response to the message:
UE policy information, and
AM policy information.

2. The device of claim 1, wherein the policy element includes a Policy Control Function ("PCF").

3. The device of claim 2, wherein the PCF implements an AM PCF and a UE PCF.

4. The device of claim 1, wherein the communication information includes an Internet Protocol ("IP") address associated with the policy element.

5. The device of claim 4, wherein the message includes a single message that is directed to the IP address associated with the policy element.

6. The device of claim 1, wherein the message includes:
an Npcf_UEPolicyControl_Create request, and
an Npcf_AMPolicyControl_Create request.

7. The device of claim 1, wherein the one or more processors are further configured to:
enforce the AM policy information with respect to the particular UE; and
provide the UE policy information to the particular UE.

8. A non-transitory computer-readable medium, storing a plurality of processor-executable instructions to:
receive communication information associated with a policy element of a wireless network that maintains User Equipment ("UE") policies and Access and Mobility ("AM") policies;
output, using the communication information, a message to the policy element, wherein the message includes:
a UE policy control request associated with a particular UE, and
an AM policy control request associated with the particular UE; and
receive, from the policy element and in response to the message:
UE policy information, and
AM policy information.

9. The non-transitory computer-readable medium of claim 8, wherein the policy element includes a Policy Control Function ("PCF").

10. The non-transitory computer-readable medium of claim 9, wherein the PCF implements an AM PCF and a UE PCF.

11. The non-transitory computer-readable medium of claim 8, wherein the communication information includes an Internet Protocol ("IP") address associated with the policy element.

12. The non-transitory computer-readable medium of claim 11, wherein the message includes a single message that is directed to the IP address associated with the policy element.

13. The non-transitory computer-readable medium of claim 8, wherein the message includes:
an Npcf_UEPolicyControl_Create request, and
an Npcf_AMPolicyControl_Create request.

14. The non-transitory computer-readable medium of claim 8, wherein the plurality of processor-executable instructions further include processor-executable instructions to:
enforce the AM policy information with respect to the particular UE; and
provide the UE policy information to the particular UE.

15. A method, comprising:
receiving communication information associated with a policy element of a wireless network that maintains User Equipment ("UE") policies and Access and Mobility ("AM") policies;
outputting, using the communication information, a message to the policy element, wherein the message includes:
a UE policy control request associated with a particular UE, and
an AM policy control request associated with the particular UE; and
receiving, from the policy element and in response to the message:
UE policy information, and
AM policy information.

16. The method of claim 15, wherein the policy element includes a Policy Control Function ("PCF") that implements an AM PCF and a UE PCF.

17. The method of claim 15, wherein the communication information includes an Internet Protocol ("IP") address associated with the policy element.

18. The method of claim 17, wherein the message includes a single message that is directed to the IP address associated with the policy element.

19. The method of claim 15, wherein the message includes:
an Npcf_UEPolicyControl_Create request, and
an Npcf_AMPolicyControl_Create request.

20. The method of claim 15, further comprising:
enforcing the AM policy information with respect to the particular UE; and
providing the UE policy information to the particular UE.
